(19) United States
(12) Patent Application Publication
(10) Pub. No.: US 2002/0083125 A1
(43) Pub. Date: Jun. 27, 2002

(54) Interactive processing system

(76) Inventors: Laurent Herrmann, Le Kremlin-Bicetre (FR); Didier Conte, Villejuif (FR)

Correspondence Address: RUSSELL GROSS, C/O PHILLIPS ELECTRONICS NORTH AMERICA CORP0RATION, CORPORATE INTELLECTUAL PROPERTY, 580 WHITE PLAINS ROAD, TARRYTOWN, NY, 10591, US

(21) Appl. No.: 09/872,994

(22) Filed: Jun. 1, 2001

(30) Foreign Application Priority Data
Jun. 6, 2000 (EP) 00401596.2

(51) Int. Cl. G06F 15/16

(52) U.S. Cl. 709/203; 709/236

(57) ABSTRACT

The invention relates to an interactive processing system comprising a user terminal intended to be connected to a network such as the Internet network by means of an interface device. This interface device first comprises means for formatting incoming data received from said terminal into packets. These packets are identified by headers, and then ready to be sent towards said network. The system also comprises means for identifying packets received from the network and forwarding them to the terminal, and means for managing and controlling the network resources and handling the delivery monitoring service of said packets on the network, according to said resources.

### FIELD OF THE INVENTION

The present invention relates to an interactive processing system comprising at least a user terminal in a user location, a server coupled to said user terminal, a communication network, and an interface device located between said network and said user terminal.

### BACKGROUND OF THE INVENTION

In order to reduce the size of the coded bitstreams associated to any type of data information transmitted by communication systems (computer data, digital speech, pictures, videosequences, audio data, . . . ), compression techniques are needed. To this end, several standards are already available (each one targeting a specific use, such as MPEG-2 for digital TV or H.263 for video-telephony). At the same time, with the emergence of multimedia applications, the need for interactivity is increasing, which implies to encode not only raw data but also information about the content of said data, such as hypertext links for example. In case of images, it means that not only a bunch of picture elements (pixels) but also a set of semantic relations between these pixels correspond to these images : such a representation defines an object. When dealing with the transmission of that object, not only the signals corresponding to the pixels but also said semantic description of the pictures have to be transmitted.

The MPEG-4 standard has been developed in order to standardize such an object-based representation of audio-visual sequences, in view of applications such as teleshopping, videogames, virtual exploration, video-telephony and other new interactive services. To provide some quality of service (QoS) for these MPEG-4 applications (or different levels of QoS according to the specific needs of the applications or of the users, said QoS depending on the bitrate, the packet loss, the transmission delay of the packets, the drift of said delay, etc., RTP (real-time transport protocol) is one of the most relevant protocols. It consists of two parts, the real-time transport protocol itself, that carries data having real-time properties (such as interactive audio and video), and the RTP control protocol (or RTCP), that monitors the quality of service (and also conveys information about the participants in an on-going session). These protocols (RTP and RTCP) are described for instance in the document U.S. Pat. No. 5,928,331. Different solutions may be used in order to provide quality of service over Internet protocol. They are assembled in a so-called RTP library which is designed in a generic way and can then be integrated in multiple kinds of applications.

### SUMMARY OF THE INVENTION

It is the object of the invention to propose an interactive processing system including a library with a low number of handling procedures.

To this end, the invention relates to a system such as defined in the introductory part of the description and in which the interface device comprises:

(a) means for formatting incoming data received from said terminal into packets identified by headers and ready to be sent towards said network;

(b) means for identifying packets received from the network and forwarding them to the terminal;

(c) means for managing and controlling the network resources and handling the delivery monitoring service of said packets on the network according to said resources.

According to this technical solution, the adaptation layer handles automatically the packets, and statistics are computed inside it. The user only has to take care of the data connections.

### BRIEF DESCRIPTION OF THE DRAWINGS

The invention will now be described in a more detailed manner, with reference to the accompanying drawings in which:

FIG. 1 illustrates the three main parts of a RTP/RTCP processing system according to the invention and shows its adaptation layer;

FIG. 2 illustrates the composition of an MPEG-4 video bitstream;

FIG. 3 illustrates an example of bitstream switching.

### DETAILED DESCRIPTION OF THE INVENTION

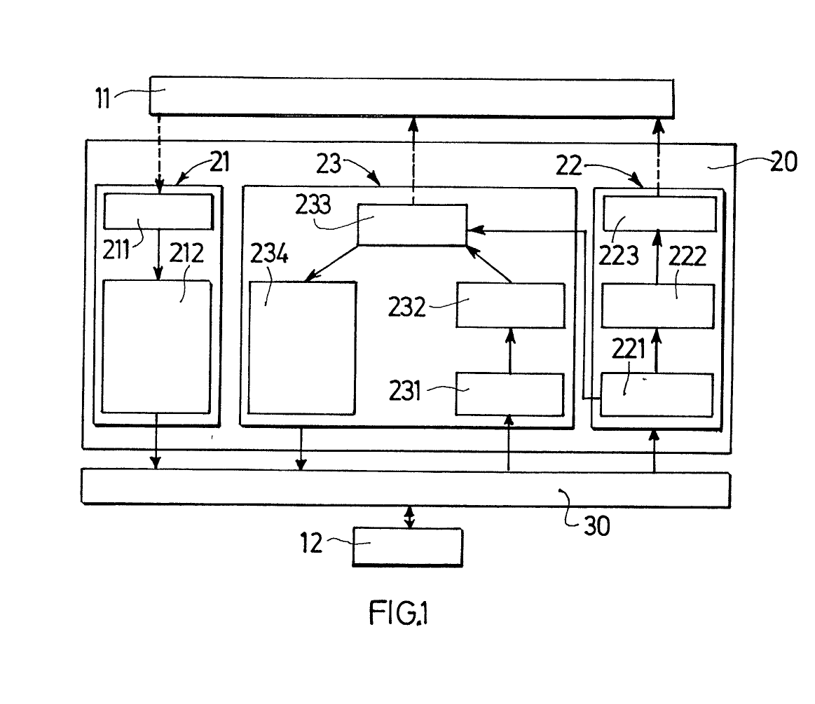

In the case of the considered protocols RTP and RTCP, the interactive processing system according to the invention, illustrated in FIG. 1, comprises a user terminal 11 (in a user location) and an application server 12 bidirectionally coupled to said user terminal by means of a communication network 30 and an interface 20 located between said network and said user terminal. The interface 20 itself comprises the following subassemblies:

(a) a formatting sub-assembly 21, that receives the input data from the current application (receiving stage 211), creates RT packets (formatting stage 212), and sends them, with RTP headers, towards the network (Internet);

(b) a retrieving sub-assembly 22, that receives RTP packets from the network (receiving stage 221), controls some parameters (control stage 222), and stores the data in view of their transmission to the current application (storing stage 223);

(c) a computing sub-assembly 23, that receives the RTCP packets arriving from the network (receiving stage 231), analyses these incoming RTCP packets (analysis stage 232), carries out the computation of all the statistical data (in a statistics processing stage 233) when RTP packets are received (calculation of the number of packet received, deduction of packet loss, delays) and when RTCP packets are received or sent (calculation of the error rate), and stores these data in a memory structure. Said structure, which can be accessed at the application level, automatically creates the RTCP packets (formatting stage 234) and sends them with RTCP headers towards the network.

According to that implementation, the RTP/RTCP protocol provides to the application statistical information about the network status. If the number of packets lost is increasing, it means that the available bandwidth is decreasing. It is then necessary to drop the server output bitrate so that the user still gets data but with a lower quality (this technique allows to have no freeze in the video display even if too many data for the transport capacity of the network continue to be sent).

Two main solutions may be contemplated for such a modification of the output bitrate. By using a real-time encoder, it is possible to adjust the bitstream bitrate very close to the need. Although efficient, this solution costs a lot of computer power. A second, simpler one consists of switching the bitstream while playing : the principle is to have a given number N of bitstreams encoded at different bitrates and to just change the bitstream to be broadcast when it is needed to change the output bitrate.

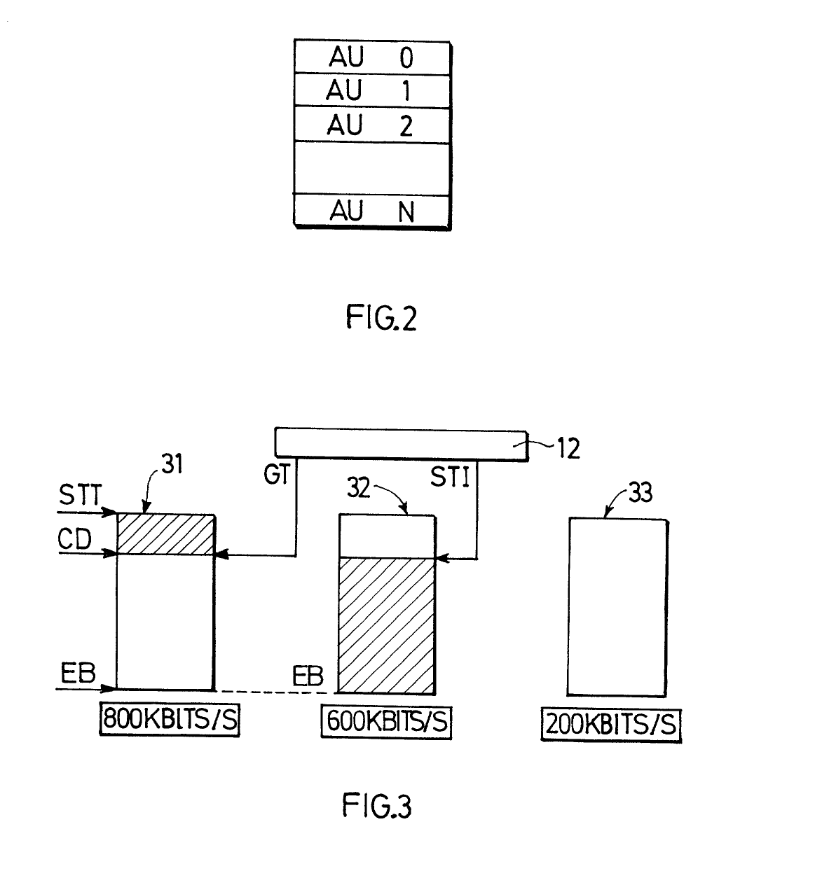

To implement said bitstream switching, it is proposed to use the MPEG-4 video Access Units feature. According to the MPEG-4 specifications, representations of multimedia objects of any natural or synthetic origin are indeed conveyed from source entities to destination entities in separate elementary streams that are encapsulated, i.e. each one of these streams is divided into so-called Access Units (AUs) which are individually accessible portions of the coded representation of the concerned multimedia object and are the smallest data entities to which time information can be attributed in the form of time stamps. As illustrated in FIG. 2, an MPEG-4 video bitstream is composed of a succession of AUs identified by the indicator of time stamps. The principle is then the following: since the server associated to the concerned application reads each AU for processing it (decoding or sending it), these time stamps will be used to control the switching operations.

An example of bitstream switching is illustrated in FIG. 3. Several source files 31, 32, 33 (three in said example) correspond to the same video information, but encoded at different bitrates, in the present case at 800, 600 and 200 kbits/second. From the instant “start time” (STT), data are read from an AU source file (for instance the source file 31 at the bitrate of 800 kbits/s) and analyzed to get access unit information (by means of a “Get Time” function GT controlled by the server 12, the time stamps associated to the AUs are detected). They are then packetized and the packets thus constituted are sent over the network.

According to the state of the network (by using the RTPI/RTCP statistics model defined within the adaptation layer, and under the supervision of an AU source file switching module included in the server 12), a congestion may be detected at the instant indicated by “congestion detected” (CD) in FIG. 3. The data sent are indicated by the hatched part. When such a congestion occurs, the AU source file switching module of the server 12 activates the “set time” function (ST) of the server in order to retrieve the time value of the AU concerned by the congestion and to use this time value to find the appropriate AU in the other AU source file towards which it is wanted to switch (in the present case, the AU source file 32, at 600 kbits/s.), up to the end of the bitstream (EB).

Later, when the network conditions become better (or worst), the server 12 can switch back to a higher (or a lower, respectively) bitrate, using the same method.

1. An interactive processing system comprising at least a user terminal in a user location, a server coupled to said user terminal, a communication network, and an interface device located between said network and said user terminal, said system being characterized in that said interface device comprises:
(a) means for formatting incoming data received from said terminal into packets identified by headers and ready to be sent towards said network;
(b) means for identifying packets received from the network and forwarding them to the terminal;
(c) means for managing and controlling the network resources and handling the delivery monitoring service of said packets on the network according to said resources.
